(19) United States
(12) Patent Application Publication
(10) Pub. No.: US 2019/0375614 A1
(43) Pub. Date: Dec. 12, 2019

(54) DEVICE FOR INSTALLING PASSENGER CONVEYOR COMPONENTS

(71) Applicant: OTIS ELEVATOR COMPANY, Farmington, CT (US)

(72) Inventor: Gregory Michael SEFCIK, Cottage Grove, WI (US)

(21) Appl. No.: 16/002,119

(22) Filed: Jun. 7, 2018

(51) Int. Cl. B66B 31/00

(52) U.S. Cl. CPC B66B 31/00

(57) ABSTRACT

An illustrative example device for installing portions of a passenger conveyor includes a base configured to be situated in a selected position on at least one of the passenger conveyor steps. A template supported on the base includes at least one balustrade position indicator situated at a preselected angle relative to the base. The balustrade position indicator defines an installation position for a balustrade supporting component of a passenger conveyor. The installation position establishes a lateral and vertical position of the balustrade supporting component relative to the at least one of the steps.

### BACKGROUND

Passenger conveyors, such as moving walkways or escalators, include a set of moving steps that carry individuals between landings at opposite ends of the conveyor. Passenger conveyors have many structural and moving parts and installing the system is challenging. For example it is time-consuming and difficult to establish a proper alignment of balustrade panels on opposite sides of the steps. If the panels are not properly aligned with each other and the rest of the conveyor assembly the overall appearance of the conveyor will be compromised. Additionally, the balustrade typically at least partially supports the handrail and proper balustrade position is necessary to facilitate proper handrail movement and operation.

### SUMMARY

An illustrative example device for installing portions of a passenger conveyor includes a base configured to be situated in a selected position on at least one of the passenger conveyor steps. A template supported on the base includes at least one balustrade position indicator situated at a preselected angle relative to the base. The balustrade position indicator defines an installation position for a balustrade supporting component of a passenger conveyor. The installation position establishes a lateral and vertical position of the balustrade supporting component relative to the at least one of the steps.

In an example embodiment having one or more features of the device of the previous paragraph, the balustrade position indicator comprises a plate having a thickness corresponding to a thickness of a balustrade panel.

In an example embodiment having one or more features of the device of any of the previous paragraphs, the plate has a lower edge aligned at the preselected angle and spaced above the base a distance corresponding to the vertical position of the balustrade supporting component.

In an example embodiment having one or more features of the device of any of the previous paragraphs, the at least one balustrade position indicator comprises two balustrade position indicators situated on opposite sides of the template.

In an example embodiment having one or more features of the device of any of the previous paragraphs, a lateral spacing between the two balustrade position indicators equals an installed distance between balustrade panels.

In an example embodiment having one or more features of the device of any of the previous paragraphs, the template comprises a frame, the frame includes side pieces situated at the preselected angle, and the side pieces define an installation position for outer decking components.

In an example embodiment having one or more features of the device of any of the previous paragraphs, the side pieces are configured to orient deck clips relative to the steps.

In an example embodiment having one or more features of the device of any of the previous paragraphs, the side pieces comprise elongated beams, the deck clips or the beams include at least one channel or groove, and the channel or groove is configured to receive a portion of the other of the deck clips or the beams.

In an example embodiment having one or more features of the device of any of the previous paragraphs, the base includes a surface configured to be received against the at least one of the steps, the base includes a plurality of tabs extending from the surface, and the tabs are configured to engage a feature of the at least one step to prevent movement of the base relative to the at least one of the steps along at least one direction.

In an example embodiment having one or more features of the device of any of the previous paragraphs, the tabs are configured to prevent movement of the base relative to the at least one of the steps along at least two generally perpendicular directions.

In an example embodiment having one or more features of the device of any of the previous paragraphs, at least one of the tabs is situated to be received adjacent a front face of the at least one of the steps.

In an example embodiment having one or more features of the device of any of the previous paragraphs, the at least one of the steps includes a plurality of grooves and at least one of the tabs is configured to be at least partially received into one of the grooves.

In an example embodiment having one or more features of the device of any of the previous paragraphs, the preselected angle is between 25 and 45 degrees.

In an example embodiment having one or more features of the device of any of the previous paragraphs, the preselected angle is 30 or 35 degrees.

In an example embodiment having one or more features of the device of any of the previous paragraphs, the base is configured to be received on a tread surface of the steps, the preselected angle is 0 degrees, and the balustrade position indicator includes a surface that is parallel to the tread surface when the base is received on the tread surface.

An illustrative example method of installing portions of a passenger conveyor includes situating a base in a selected position on at least one of the passenger conveyor steps. The base supports a template that includes at least one balustrade position indicator situated at a preselected angle relative to the base. A balustrade supporting component of the passenger conveyor is installed in an installation position defined by the balustrade position indicator. The installation position includes a lateral and vertical position of the balustrade supporting component relative to the at least one of the steps. The method includes removing the base and the template from the at least one of the steps after the balustrade supporting component is installed and installing a portion of a balustrade on the balustrade supporting component.

An example embodiment having one or more features of the method of the previous paragraph includes repeating the situating, installing and removing at several of the steps.

In an example embodiment having one or more features of the method of any of the previous paragraphs, the template comprises a frame, the frame includes side pieces situated at the preselected angle, and the method comprises installing outer decking components in an installation position defined by the side pieces.

In an example embodiment having one or more features of the method of any of the previous paragraphs, the base includes a surface configured to be received against the at least one of the steps, the base includes a plurality of tabs extending from the surface, and the method includes engaging the tabs with at least one feature of the at least one step to prevent movement of the base relative to the at least one of the steps along at least one direction.

An example embodiment having one or more features of the method of any of the previous paragraphs includes engaging the tabs with the at least one of the steps to prevent movement of the base relative to the at least one of the steps along at least two generally perpendicular directions.

Various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 diagrammatically illustrates an example passenger conveyor.

FIG. 2 diagrammatically illustrates a device for installing passenger conveyor components designed according to an embodiment of this invention.

FIG. 3 shows an underside of the device shown in FIG. 2.

FIG. 4 illustrates a portion of a passenger conveyor assembly process including the device of FIG. 2 situated on one of the passenger conveyor steps.

FIG. 5 is a side elevational view of an example balustrade supporting component and a portion of the device of FIG. 2.

FIG. 6 illustrates installation of an example side decking component using the device of FIG. 2.

FIG. 7 illustrates installation another aspect of using the device of FIG. 2 to install the example side decking component.

FIG. 8 diagrammatically illustrates another example device designed according to an embodiment of this invention.

### DETAILED DESCRIPTION

Embodiments of this invention facilitate quicker and easier passenger conveyor installation and assembly. An example disclosed embodiment facilitates installing balustrade panels by assisting a technician in positioning balustrade positioning components relative to the steps of the passenger conveyor. The example embodiment also facilitates accurately installing side decking components.

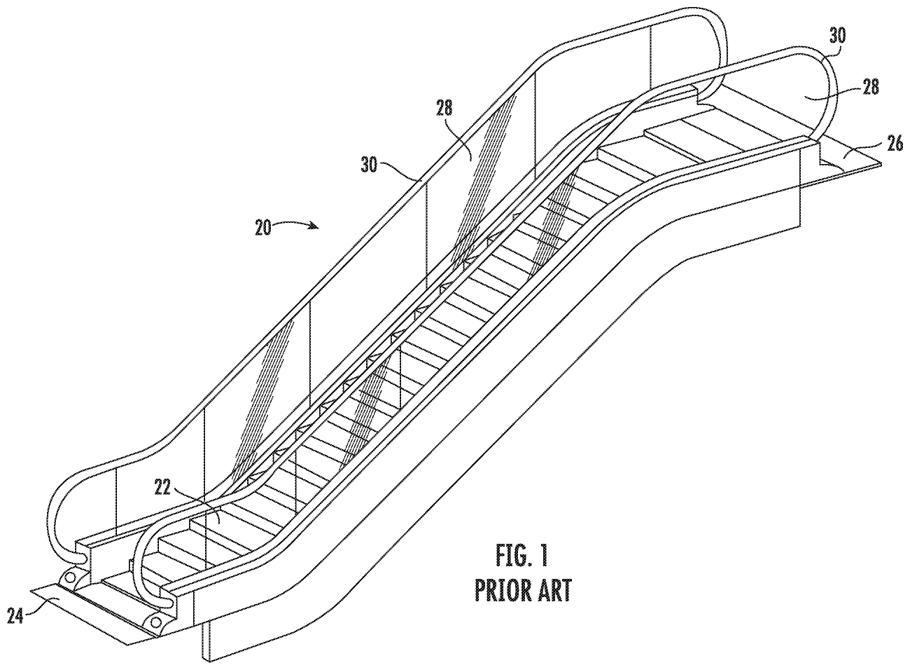

FIG. 1 diagrammatically illustrates a passenger conveyor 20. In this example, the passenger conveyor 20 is an escalator. In other embodiments, the passenger conveyor is a moving walkway. The passenger conveyor 20 includes a plurality of steps 22 that are moveable to carry passengers between landings 24 and 26. Balustrade panels 28 are situated on opposite sides of the steps 22. The balustrade panels provide at least some support for handrails 30 that move with the steps 22. The components and operation of the example passenger conveyor 20 are known.

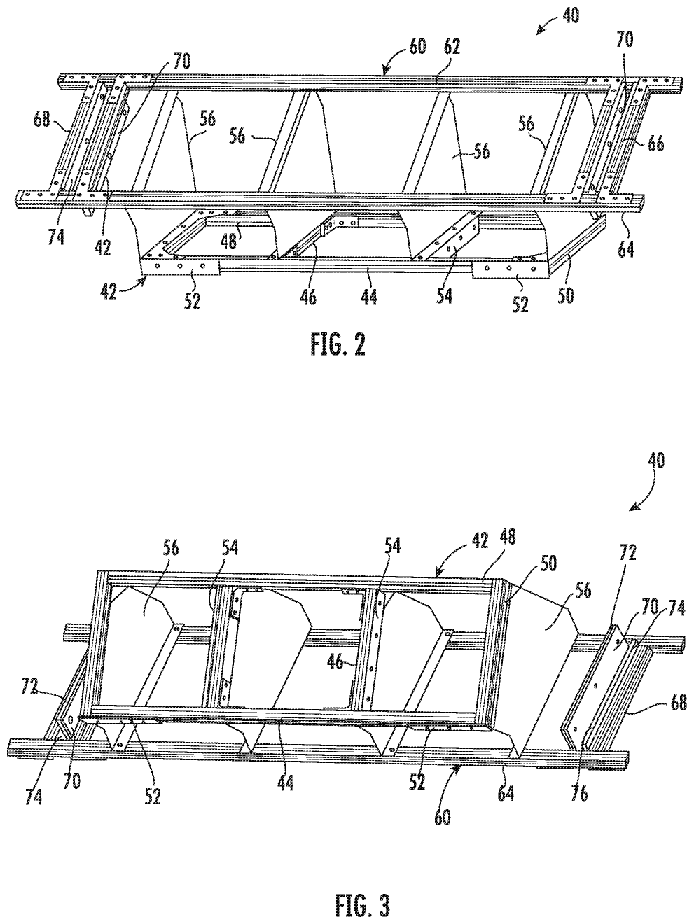

FIGS. 2 and 3 illustrate an example embodiment of a device 40 that facilitates installing components of a passenger conveyor such as the conveyor 20. The device 40 includes a base 42 that is configured to be situated on at least one of the steps 22 of the conveyor 20. The base 42 includes a plurality of beams or rods 44, 46, 48 and 50 that establish a rectangular frame. In this example the frame of the base 42 has a width corresponding to a width of the steps 22.

The base 42 includes a plurality of tabs extending from the surface of the base 42 that is configured to be received on one of the steps 22. The tabs in this example include tabs 52 secured to the beam 44 with a portion of the tabs 52 extending beyond the beam 44 where the tabs 52 can be received against a front edge of a step 22 to set a position of the device 40 relative to the front edge of the step. The tabs 52 prevent movement of the base 42 of the device 40 relative to a selected step 22 in a first direction (e.g., front-to-back).

Other tabs 54 are situated perpendicular to the tabs 52. The tabs 54 are situated on the base in positions where the tabs 54 can be at least partially received in grooves on a step 22. The tabs 54 establish a lateral position of the device 40 relative to a selected step 22 and prevent movement of the base 42 relative to a selected step in a second direction (e.g., side-to-side). The tabs 52 and 54 collectively serve to prevent movement of the base 42 of the device relative to a selected step 22 in two perpendicular directions. Maintaining a stable position of the device 40 relative to a selected step 22 facilitates accurate installation or positioning of components of the conveyor 20.

The example device 40 includes supports 56 that support a template 60 at a selected angle relative to the base 42. In this example, the angle between the template 60 and the base 42 is between 30 degrees and 45 degrees. An example embodiment includes an angle of 35 degrees. The angle at which the template 60 is situated relative to the base corresponds to an angle of the balustrade panels 30 relative to a tread surface on the steps along the sides of the conveyor 20 once those panels are installed.

The template includes a plurality of beams or rods 62, 64, 66 and 68. Balustrade position indicators 70 are secured to the beams 66 and 68, respectively. The balustrade position indicators 70 comprise plates having lower edges 72 aligned relative to the base 42 at the angle at which the balustrade panels 30 will be situated once installed.

In this embodiment, depth gauge plates 74 are situated near and parallel to the balustrade position indicators 70. The depth gauge plates 74 include lower edges 76 that facilitate aligning a balustrade panel holder.

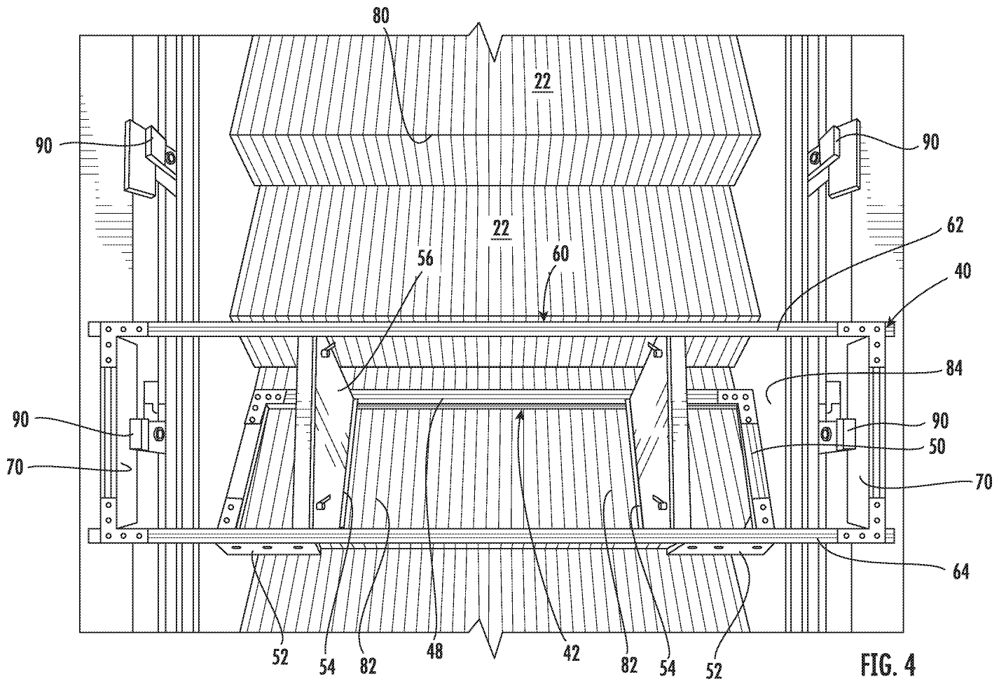

A method of using the device 40 includes situating the device 40 on one of the steps 22 as shown in FIG. 4. The base 42 is received against or on the tread surface of a selected step 22 with the tabs 52 received against a front edge 80 of the step and the tabs 54 at least partially received in respectively corresponding grooves 82 on the tread surface of the step 22. In the illustrated example the width of the base 42 is approximately equal to a lateral spacing between skirt panels 84 on opposite sides of the steps, which further facilitates situating the device in a proper position on the selected step 22.

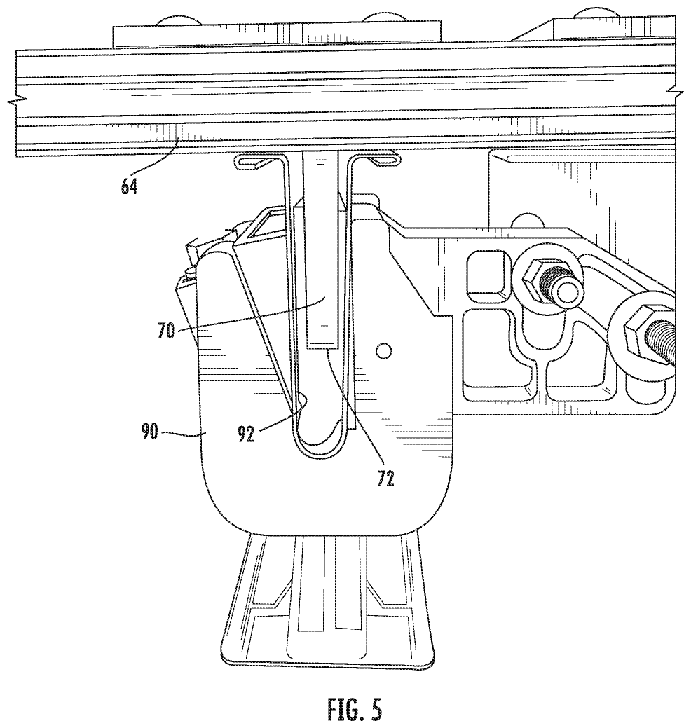

With the device 40 in the position shown in FIG. 4 it is possible for a technician or mechanic to install components of the passenger conveyor, such as balustrade panel supporting components 90. As can be appreciated in FIG. 5, the balustrade position indicators 70 are received in a channel 92 of the respective balustrade panel support 90. The plates of the balustrade position indicators 70 in this example have a thickness corresponding to a thickness of the balustrade panels 30 and the edges 72 facilitate accurately aligning the balustrade panel supports 90. The distance between the balustrade position indicators 70 establishes the finish or installed spacing between the balustrade panels 30 once installed.

In FIG. 4 one set of balustrade panel supports 90 closer to the top of the illustration were installed when the device 40 was situated on the step 22 above the step 22 on which the device 40 is situated in the illustration. After those supports 90 were secured in place, the device 40 was removed from that step and placed on the step as illustrated to install the lower (according to the drawing) set of supports 90. The device 40 can be sequentially placed on a selected step 22, used to install selected components, removed from that step, and placed on another step to install or position additional conveyor components until the entire installation of such components is complete.

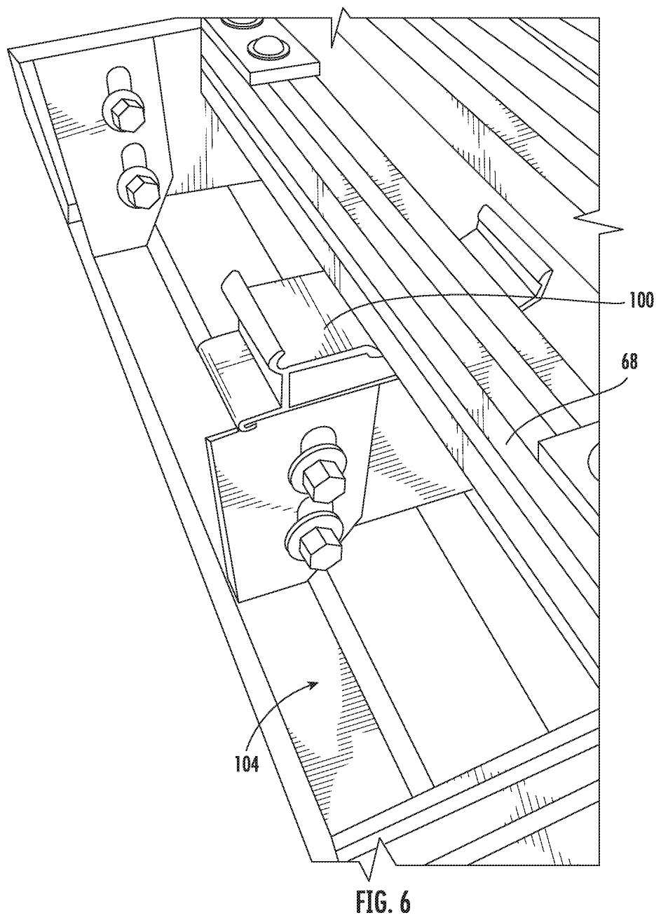

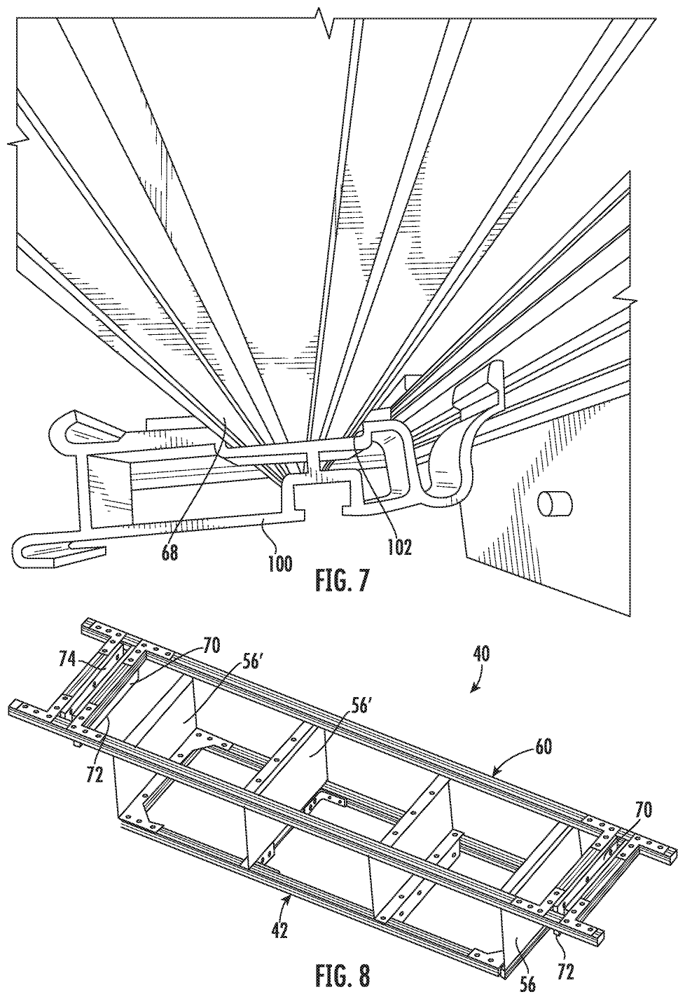

The example device 40 is also useful for installing or positioning outer deck components of the conveyor 20. FIGS. 6 and 7 show an example installation of outer decking clips 100. The frame members of the template 60, such as the beam 68 facilitate properly positioning and aligning outer decking clips 100 by accommodating such clips. In this example, the beam 68 has a width that corresponds to a channel or groove 102 on the decking clips 100 so that the decking clips 100 can be reliably positioned relative to the device 40 in a properly aligned installation position where the clips 100 are secured in place as part of the outer decking 104.

The device 40 shown in FIGS. 2 and 3 is useful for setting the balustrade and outer decking components, for example, along the incline section of the passenger conveyor 20. The device 40 shown in FIG. 8 is useful for setting the balustrade and outer decking components along the ends of the passenger conveyor 20 near the landings 24 and 26. In this example, the supports 56′ situate the template 60 at a different angle relative to the base 42 compared to the angle provided in FIGS. 2 and 3. In FIG. 8, the template 60 and the base 42 are parallel to each other. The lower edges 72 of the balustrade position indicators 70 establish a position for the finish edge of the balustrade panels 30 near the landings 24, 26 that is parallel to the tread surfaces of the steps and the floor surfaces near the landings.

Devices designed according to an embodiment of this invention may be used to install or position other passenger conveyor components that are not illustrated or discussed above. Devices designed according to an embodiment of this invention facilitate faster, more efficient and more accurate placement of passenger conveyor components during installation or adjustment procedures.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A device for installing portions of a passenger conveyor that includes a plurality of steps, the device comprising:
a base configured to be situated in a selected position on at least one of the steps; and
a template supported on the base, the template including at least one balustrade position indicator situated at a preselected angle relative to the base, the balustrade position indicator defining an installation position for a balustrade supporting component of a passenger conveyor, the installation position establishing a lateral and vertical position of the balustrade supporting component relative to the at least one of the steps.

2. The device of claim 1, wherein the balustrade position indicator comprises a plate having a thickness corresponding to a thickness of a balustrade panel.

3. The device of claim 2, wherein the plate has a lower edge aligned at the preselected angle and spaced above the base a distance corresponding to the vertical position of the balustrade supporting component.

4. The device of claim 1, wherein the at least one balustrade position indicator comprises two balustrade position indicators situated on opposite sides of the template.

5. The device of claim 4, wherein a lateral spacing between the two balustrade position indicators equals an installed distance between balustrade panels.

6. The device of claim 1, wherein
the template comprises a frame;
the frame includes side pieces situated at the preselected angle; and
the side pieces define an installation position for outer decking components.

7. The device of claim 6, wherein the side pieces are configured to orient deck clips relative to the steps.

8. The device of claim 7, wherein
the side pieces comprise elongated beams;
the deck clips or the beams include at least one channel or groove; and
the channel or groove is configured to receive a portion of the other of the deck clips or the beams.

9. The device of claim 1, wherein
the base includes a surface configured to be received against the at least one of the steps;
the base includes a plurality of tabs extending from the surface; and
the tabs are configured to engage a feature of the at least one step to prevent movement of the base relative to the at least one of the steps along at least one direction.

10. The device of claim 9, wherein the tabs are configured to prevent movement of the base relative to the at least one of the steps along at least two generally perpendicular directions.

11. The device of claim 9, wherein at least one of the tabs is situated to be received adjacent a front face of the at least one of the steps.

12. The device of claim 9, wherein
the at least one of the steps includes a plurality of grooves; and
at least one of the tabs is configured to be at least partially received into one of the grooves.

13. The device of claim 1, wherein the preselected angle is between 25 and 45 degrees.

14. The device of claim 13, wherein the preselected angle is 30 or 35 degrees.

15. The device of claim 1, wherein
the base is configured to be received on a tread surface of the steps;
the preselected angle is 0 degrees; and
the balustrade position indicator includes a surface that is parallel to the tread surface when the base is received on the tread surface.

16. A method of installing portions of a passenger conveyor that includes a plurality of steps, the method comprising:
situating a base in a selected position on at least one of the steps, the base supporting a template that includes at least one balustrade position indicator situated at a preselected angle relative to the base;
installing a balustrade supporting component of the passenger conveyor in an installation position defined by the balustrade position indicator, the installation position including a lateral and vertical position of the balustrade supporting component relative to the at least one of the steps;
removing the base and the template from the at least one of the steps after the balustrade supporting component is installed; and
installing a portion of a balustrade on the balustrade supporting component.

17. The method of claim 16, comprising repeating the situating, installing and removing at several of the steps.

18. The method of claim 16, wherein
the template comprises a frame;
the frame includes side pieces situated at the preselected angle; and
the method comprises installing outer decking components in an installation position defined by the side pieces.

19. The method of claim 16, wherein
the base includes a surface configured to be received against the at least one of the steps;
the base includes a plurality of tabs extending from the surface; and
the method includes engaging the tabs with at least one feature of the at least one step to prevent movement of the base relative to the at least one of the steps along at least one direction.

20. The method of claim 19, comprising engaging the tabs with the at least one of the steps to prevent movement of the base relative to the at least one of the steps along at least two generally perpendicular directions.
